(19) United States
(12) Patent Application Publication
(10) Pub. No.: US 2012/0115016 A1
(43) Pub. Date: May 10, 2012

(54) BATTERY MODULE

(76) Inventor: Myung-Chul Kim, Yongin-si (KR)

(21) Appl. No.: 13/238,642

(22) Filed: Sep. 21, 2011

(30) Foreign Application Priority Data
Nov. 4, 2010 (KR) 10-2010-0109179

(51) Int. Cl. H01M 2/10; H01R 25/00

(52) U.S. Cl. 429/159; 439/110

(57) ABSTRACT

A battery module array includes a plurality of battery modules each having a plurality of battery cells, each of the battery cells including a terminal surface through which electrode terminals are exposed and a bottom surface substantially opposite to the terminal surface, wherein the bottom surface of each of the battery cells are fixed together such that the exposed electrode terminals extend away from each other; and a bus bar coupling the electrode terminals of two adjacent ones of the battery modules to each other, the bus bar being made of a conductive metal material, wherein the bus bar has a curved center portion and has an electrode accommodating hole on either side of the curved center portion.

### CROSS-REFERENCE TO RELATED APPLICATION

This application claims priority to and the benefit of Korean Patent Application No. 10-2010-0109179, filed on Nov. 4, 2010, in the Korean Intellectual Property Office, the entire content of which is incorporated herein by reference.

### BACKGROUND

1. Field

An embodiment of the present invention relates to a bus bar and a battery module array including the same.

2. Description of Related Art

In general, a secondary battery may be re-used by discharging and recharging unlike a primary battery that cannot be recharged. The secondary battery is often used as the energy source of a mobile apparatus, an electric vehicle, a hybrid vehicle, an electric bicycle, and as an uninterruptible power supply. In accordance with the type of applied external apparatus, a single battery may be used or a battery module in which a plurality of batteries are coupled to each other may be used.

A small mobile apparatus such as a cellular phone may be operated for a period of time with the output and capacity of a single battery. However, an electric vehicle and a hybrid vehicle with have a large power consumption and can be driven for a long time generally require a battery module due to the output and capacity requirements. The battery module may include serially coupled batteries and may include batteries coupled in parallel in accordance with the output and the capacity to be used.

### SUMMARY

Accordingly, the present invention has been made to provide a battery module array capable of performing stable electric coupling between horizontal arrangement battery modules and having a coupling structure capable of absorbing shock from the outside.

In one embodiment, a battery module array includes a plurality of battery modules each having a plurality of battery cells, each of the battery cells including a terminal surface through which electrode terminals are exposed and a bottom surface substantially opposite to the terminal surface, wherein the bottom surface of each of the battery cells are fixed together such that the exposed electrode terminals extend away from each other; and a bus bar coupling the electrode terminals of two adjacent ones of the battery modules to each other, the bus bar being made of a conductive metal material, wherein the bus bar has a curved center portion and has an electrode accommodating hole on either side of the curved center portion.

In one embodiment, a probe hole configured to receive a voltage testing apparatus is located adjacent to at least one electrode accommodating hole. Further, an insulating layer may be on the curved center portion.

In another embodiment, a vertical coupling bus bar for a battery module is provided, the bus bar being made of a conductive metal material and including a first terminal extending in a first plane and having a first electrode terminal accommodating hole; a coupling unit extending in a second plane substantially perpendicular to the first plane and being coupled to the first terminal; and a second terminal spaced from and extending substantially parallel to the first terminal and coupled to the coupling unit, wherein the second terminal has a second electrode terminal accommodating hole.

In another embodiment, an array coupling type bus bar is provided, the bus bar being made from a conductive metal material and including a first terminal extending in a first plane and having a first electrode terminal accommodating hole; a first extending unit extending in a second plane substantially perpendicular to the first plane and coupled to the first terminal; and a second extending unit extending in a third plane substantially perpendicular to the first plane and the second plane and coupled to the first extending unit.

In one embodiment, the array coupling type bus bar further includes a module coupling unit comprising a conductive metal material and fastened to the second extending unit by a fastener. Additionally, in one embodiment, the second extending unit and the module coupling unit are coupled to each other by an integrated stud bolt.

In one embodiment, the battery array includes a plurality of pairs of battery cells laminated together, wherein the pairs of battery cells are stacked to form layers, wherein end plates are provided on ends of the battery array, and wherein a fixing member is coupled to the end plates to fix the battery cells in the battery array.

In order to achieve the foregoing and/or other aspects of the present invention, there is provided a horizontal coupling type bus bar formed of a conductive metal material, having a curved part formed in a center, and having electrode accommodating holes formed on both sides of the curved part.

A second probe hole of a voltage testing apparatus is formed outside the at least one electrode accommodating hole.

An insulating layer is formed on an external surface of the curved part.

A vertical coupling bus bar is formed of a conductive metal material and includes a first terminal, a coupling unit, a coupling unit, and a second terminal. The first terminal is provided on a first plane and has a first electrode terminal accommodating hole. The coupling unit is provided on a second plane perpendicular to the first plane, is coupled to the first terminal, and is extended downward along the second plane. The second terminal is provided below the first terminal on the first plane, is coupled to the coupling unit, and has a second electrode terminal accommodating hole.

A second probe hole of a voltage testing apparatus is formed outside the at least one electrode accommodating hole.

In addition, an insulating layer is formed on an external surface of the coupling unit.

An array coupling type bus bar is formed of a conductive metal material and includes a first terminal, a first extending unit, and a second extending unit. The first terminal is provided on a first plane and has a first electrode terminal accommodating hole. The first extending unit is provided on a second plane perpendicular to the first plane and is coupled to the first terminal. The second extending unit is provided on a third plane perpendicular to the first plane and the second plane and is coupled to the first extending unit.

Insulating layers are formed on the external surfaces of the first extending unit and the second extending unit.

The array coupling type bus bar may further includes a module coupling unit formed of a conductive metal material and fastened to the second extending unit by a screw fastening method.

The second extending unit and the module coupling unit are coupled to each other by an integrated stud bolt.

An insulating layer is formed on an external surface of the module coupling unit.

A second probe hole of a voltage testing apparatus is formed outside the at least one electrode accommodating hole.

There is provided a battery module array, including a plurality of battery modules including a battery array in which battery cells including terminal surfaces through which both electrode terminals are exposed and opposite bottom surfaces are laminated and end plates fixed to terminal surfaces so that the both electrode terminals are exposed and bus bars for coupling electrode terminals of two adjacent battery modules to each other.

In the battery array, a pair of battery cells horizontally arranged so that bottom surfaces face each other are laminated to form layers. The end plates are provided on both terminals of the battery array. Fixing member coupled to the end plates to fix the battery array.

The bus bars according to the present invention and the battery modules may be stably electrically coupled to each other by the bus bars. At the same time, external shock may be effectively absorbed so that stiffness may be improved.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a perspective view illustrating an example of a horizontal arrangement type battery module;

FIG. 1B is an exploded perspective view illustrating the battery module of FIG. 1A;

FIG. 2A is a perspective view illustrating an example of an end plate;

FIG. 2B is a schematic diagram illustrating that the end plate of FIG. 2A is coupled to laminated battery cells;

FIG. 3 is a schematic diagram illustrating an example of electric coupling between the battery modules of FIG. 1A;

FIG. 4A is a perspective view illustrating a horizontal coupling type bus bar according to an embodiment;

FIG. 4B is a sectional view illustrating the bus bar of FIG. 4A;

FIG. 4C is a perspective view illustrating a horizontal coupling type bus bar according to another embodiment;

FIG. 5 is a perspective view illustrating a coupling structure between battery modules in which the horizontal coupling type bus bar of FIG. 4A is used;

FIG. 6A is a perspective view illustrating a vertical coupling type bus bar according to an embodiment;

FIGS. 6B and 6C are perspective views illustrating vertical coupling type bus bar according to other embodiments;

FIG. 7 is a perspective view illustrating that electrode terminals are coupled to each other using the bus bar of FIG. 6A;

FIG. 8 is an exploded perspective view illustrating an array coupling type bus bar according to an embodiment;

FIG. 9 is a perspective view illustrating that the terminal of FIG. 8 is provided in a battery module; and

FIG. 10 is a perspective view illustrating that electrode terminals are coupled to each other using the bus bar of FIG. 8.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Hereinafter, like reference numerals refer to like elements.

Hereinafter, the embodiments of the present invention will be described with reference to the attached drawings. When there is no special definition or comment, the terms for representing directions such as ‘up and down and left and right’ are based on the state displayed on the drawing. In addition, the same members are denoted by the same reference numerals.

Hereinafter, a battery array refers to a plurality of accumulated or arranged battery cells. The battery module array means a plurality of battery modules arranged to be electrically coupled to each other and/or physically coupled to each other.

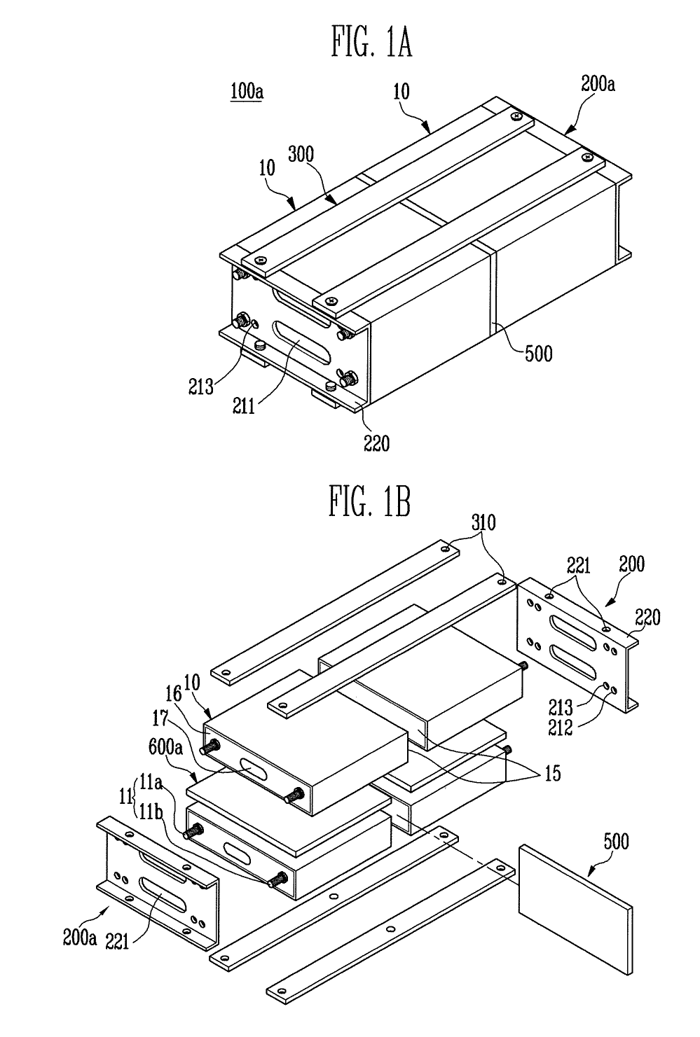

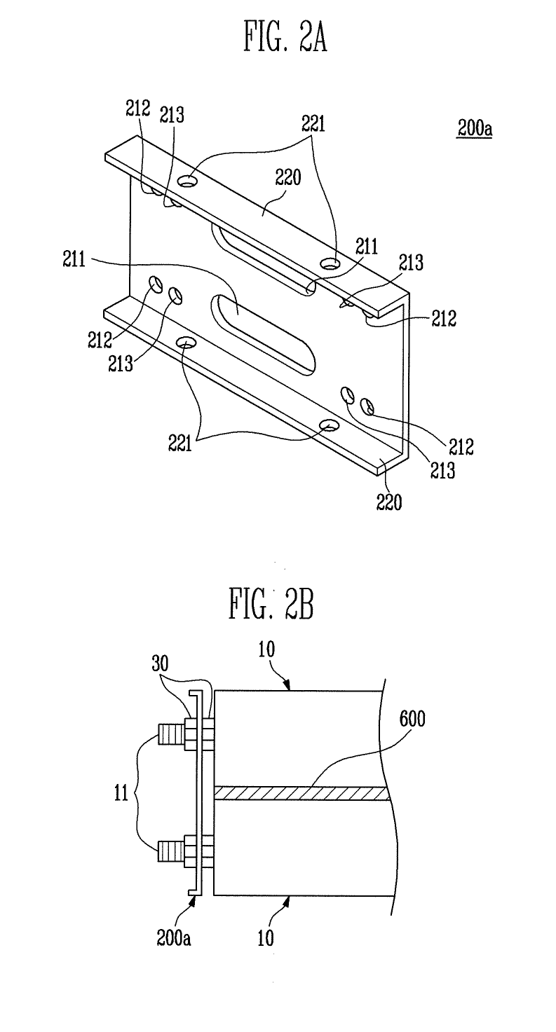

A battery module will be described with reference to FIGS. 1A to 2B. FIG. 1A is a perspective view illustrating an example of a horizontal arrangement type battery module. FIG. 1B is an exploded perspective view illustrating the battery module of FIG. 1A. FIG. 2A is a perspective view illustrating an example of an end plate. FIG. 2B is a schematic diagram illustrating that the end plate of FIG. 2A is coupled to laminated battery cells

The present invention may be applied to the horizontal arrangement type battery module 100a illustrated in FIG. 1. The horizontal arrangement type battery module 100a may be divided into a plurality of battery cells 10 that constitute a battery array, a structure for insulation, and a structure for fixation.

Electrode terminals 11 (a positive terminal 11b and a negative terminal 11a) and a vent 17 are provided on a terminal surface 16. The vent 17 is formed generally in the center of the terminal surface 16 and is configured to discharge gas generated by the battery cell 10. The electrode terminals 11 are provided on either side of the vent 17 and function as paths through which the current generated by the battery cell 10 is coupled to the outside. In addition, hereinafter, the opposite side of the terminal surface is referred to as a bottom surface 15.

In one embodiment, a battery array may be formed by laminating the battery cells 10 because laminating the two battery cells 10 to form one layer can maximize space efficiency. As illustrated in FIG. 1B, the two battery cells 10 may be horizontally arranged so that the bottom surfaces 15 face each other, which orients the electrode terminals 11 to face the outside (i.e., the exposed electrode terminals extend away from each other). The pair of arranged battery cells 10 are laminated to form no fewer than two layers as illustrated in FIG. 2B, although the present invention may be applied for other configurations of battery cells, even when the battery cells 10 form fewer than two layers.

Top and bottom fixing members 300 and end plates 200 may be provided as the structure for fixation. The top and bottom fixing members 300 are fixed to the top and bottom ends of the end plates 200 to limit the up and down motion of the battery cells in the battery array 10 with respect to each other. A vertical insulating member 500 and a horizontal insulating member 600a may be provided as insulating members. The vertical insulating member 500 is provided between the bottom surfaces 15 of the two battery cells 10 that face each other to insulate the battery cells from each other. The horizontal insulating member 600 is provided between pairs of laminated battery cells 10 to insulate adjacent pairs of laminated battery cells from each other.

The end plate 200a is a fixing member for fixing the above-described laminated battery cells 10. According to the present embodiment, an end plate 200 used for a horizontal arrangement battery module laminated in two layers will be described. In each of the upper and lower ends of the end plate 200a, a pair of first fastening holes 221 configured for fastening by a screw method are formed. In order to easily form the first fastening holes 221, first extending units 220 extended from the upper and lower ends of the end plate 200a to form a right angle may be further formed. The first fastening holes 221 are formed to penetrate the first extending units 220.

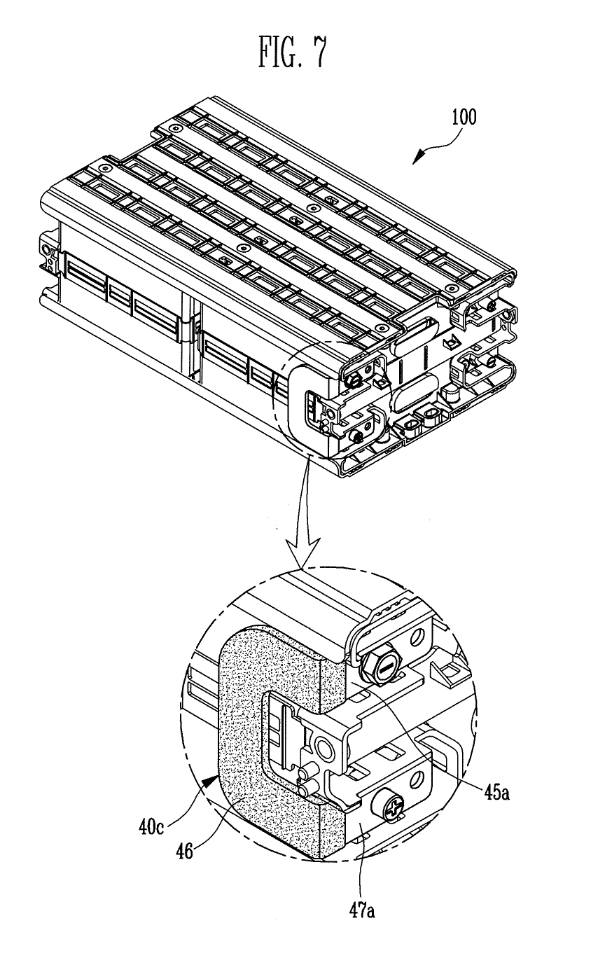

In addition, exhausting holes 211 are formed in the upper and lower centers of the end plate 200. The exhausting holes 211 are formed to have the shapes corresponding to the above-described vents 17 in the corresponding positions. In addition, electrode holes 212 are formed on either side of the exhausting holes 211. According to the present embodiment, in the case of the battery module laminated in two layers, four electrode holes 212 are provided. As illustrated in FIG. 7, the electrode terminals 11 of the battery cell 10 are exposed through the electrode holes 212. In one embodiment, male screws are processed on the outer circumference of the electrode terminals 11 and both sides of the end plate 200 are tightened by nuts to fix the battery cells 10 and the end plates 200 to each other.

In one embodiment, probe holes 213 may be formed between the electrode holes 212 and the exhausting holes 211. The probe units of various apparatuses may be inserted into or out through the probe holes 213 in order to test the voltages of the battery cells that constitute the battery module.

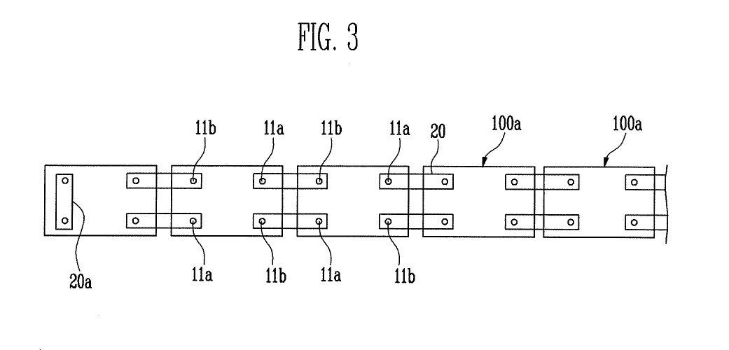

Referring to FIG. 3, the electric coupling relationship of the horizontal arrangement type battery modules will be simply described. The plurality of battery modules 100a are serially coupled to each other or are coupled to each other in parallel so that the battery modules 100a have desired output and capacity. The plurality of serially coupled battery modules will be illustrated in FIG. 3.

As illustrated in FIG. 3, the electrodes of the battery modules 100a are coupled to each other using uniform conductive coupling members 20 (hereinafter, referred to as bus bars). First, in the battery module 100a, battery cells are provided so that positive terminals 11b are provided on the left and that the negative terminals 11a are arranged in the upper parts. In addition, in the battery module 100a, the battery cells are provided so that the negative terminals 11a are arranged on the left and that the positive terminals 11b are arranged on the right in the lower parts. In other words, the electrode terminals 11 of the battery module 100 are to be provided so that they alternate.

Then, the electrode terminals 11 between the adjacent battery modules 100a are coupled to each other using the bus bars 20. When there are no adjacent electrode terminals 11, the electrode terminals 11 provided in the upper and lower part are coupled to each other in the same battery module 100a so that one electric path is formed.

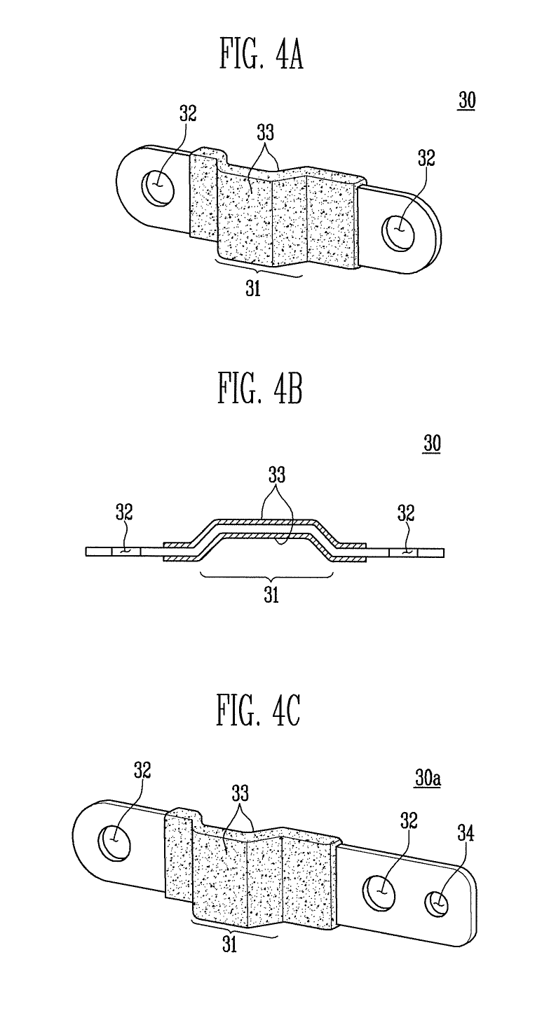

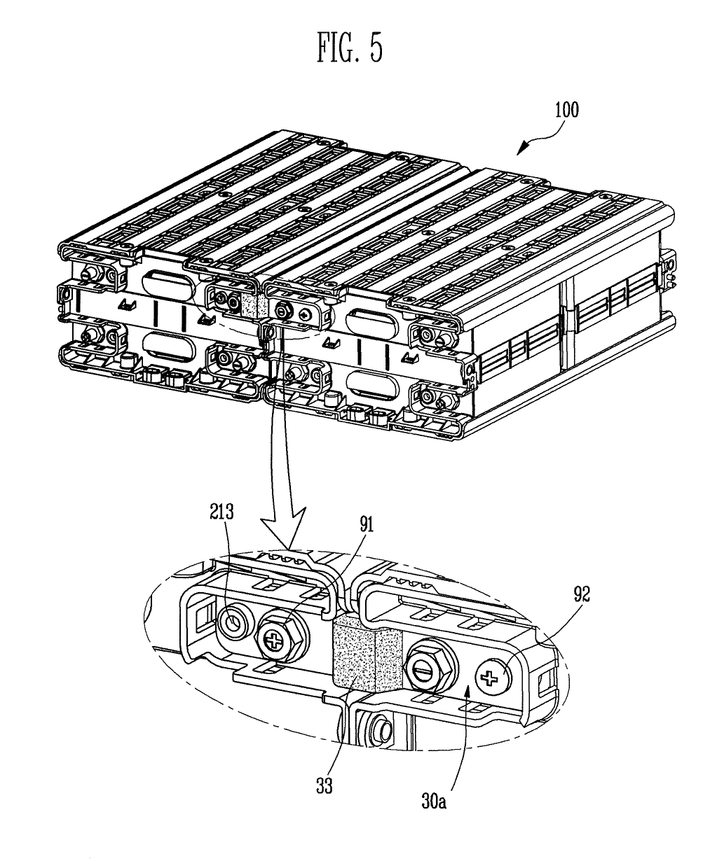

A horizontal coupling type bus bar will be described with reference to FIGS. 4A to 5. FIG. 4A is a perspective view illustrating a horizontal coupling type bus bar according to an embodiment. FIG. 4B is a sectional view illustrating the bus bar of FIG. 4A. FIG. 4C is a perspective view illustrating a horizontal coupling type bus bar according to another embodiment. FIG. 5 is a perspective view illustrating a coupling structure between battery modules in which the horizontal coupling type bus bar of FIG. 4A is used.

A horizontal coupling type bus bar 30 is formed of a conductive metal material such as nickel and copper.

The horizontal coupling type bus bar 30 is in the form of a thin rod. In addition, a curved part 31 is formed in the center. The curved part 31 helps the horizontal coupling type bus bar 30 absorb external shock by substantially uniform elasticity. Electrode accommodating holes 32 are formed on either side of the curved part 31. Additionally, second probe holes 34 corresponding to the above-described probe holes of the end plate may be formed outside the electrode accommodating holes 32. The second probe holes 34 may be formed outside the electrode accommodating holes 32 and may be formed outside one electrode accommodating hole 32 as illustrated in FIG. 4C. In the case of the asymmetric bus bar 30 illustrated in FIG. 4C, weight may be minimized.

As illustrated in FIG. 5, the horizontal coupling type bus bar 30a is used for coupling the adjacent battery modules 100 to each other. The horizontal coupling type bus bar 30a accommodates the electrodes of the battery module 100 through electrode accommodating units and fixes the electrodes using fastening members 91 such as nuts. As described above, when an asymmetrical bus bar 30a is used, since one probe hole 213 is exposed, the probe of a measuring apparatus may be inserted. The probe hole 213 is fixed using a fastening member 92 such as an additional bolt through the second probe hole so that the fastening force of the horizontal coupling type bus bar 30 may be improved. On the other hand, when the battery modules 100 are coupled to each other using the horizontal coupling bus bars 30, curved parts 33 may be exposed to the external surface. Therefore, an insulating layer formed of synthetic resin may be formed on the external surface of the curved part 33.

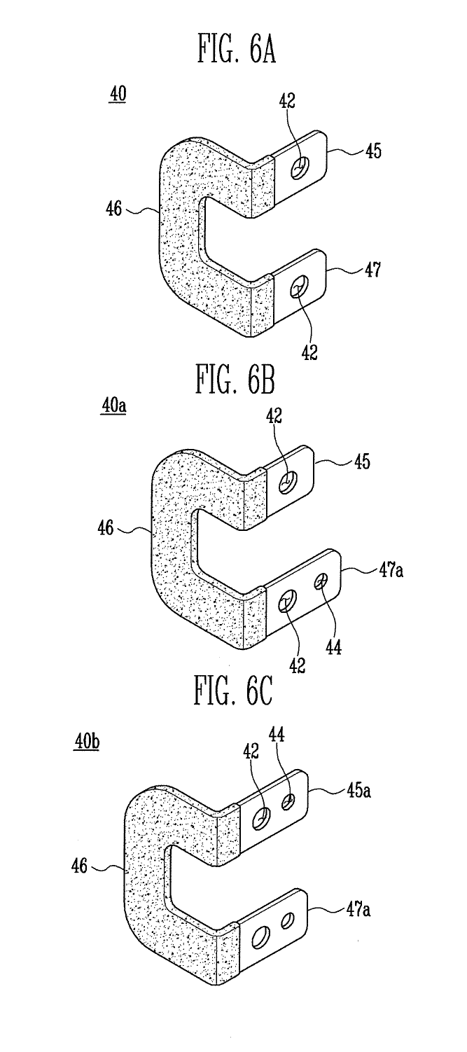

A vertical coupling type bus bar will be described with reference to FIGS. 5A to 7. FIG. 6A is a perspective view illustrating a vertical coupling type bus bar according to an embodiment. FIGS. 6B and 6C are perspective views illustrating vertical coupling type bus bar according to another embodiment. FIG. 7 is a perspective view illustrating that electrode terminals are coupled to each other using the bus bar of FIG. 6A.

The vertical coupling type bus bar is divided into a first terminal 45, a coupling unit 46, and a second terminal 47. A plane in which the first terminal 45 extends is referred to as a first plane, and the coupling unit is extended to be bent from the first terminal 45 to extend in a second plane substantially perpendicular to the first plane, i.e., vertically, as shown in FIG. 6A. The second terminal 47 is bent from the lower end of the coupling unit 46 toward the first plane to be extended along the first plane. A first electrode terminal accommodating hole 42 is formed in the first terminal 45 and a second electrode terminal accommodating hole 42 is formed in the second terminal 47. In addition, like in the above-described horizontal coupling type bus bar, a second probe hole 44 may be formed. In one embodiment, as illustrated in FIG. 6B, the vertical coupling type bus bar may be asymmetrical and, as illustrated in FIG. 6C, second probe holes 44 may be formed in the first terminal 45 and the second terminal 47.

As illustrated in FIG. 7, in a vertical coupling type bus bar 40c, a first terminal 45a is provided in the electrode terminal in the upper end of the terminal of the battery module 100, the coupling unit 46 is provided on the side surface of the battery module 100, and a second terminal 47a is provided in the lower end electrode terminal of the battery module 100. As described above, the upper and lower electrode terminals are electrically coupled to each other.

In addition, an insulating layer may be formed on the external surface of the coupling unit 46 that may be exposed to the outside as described above.

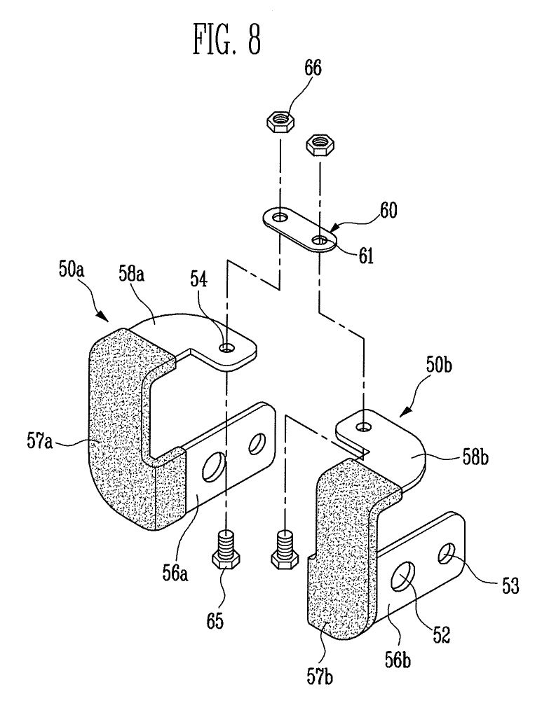

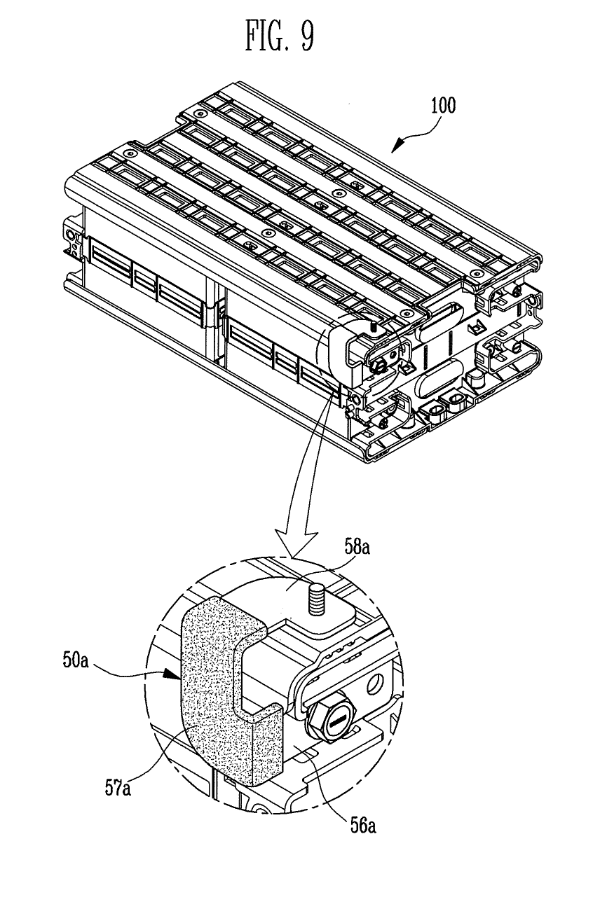

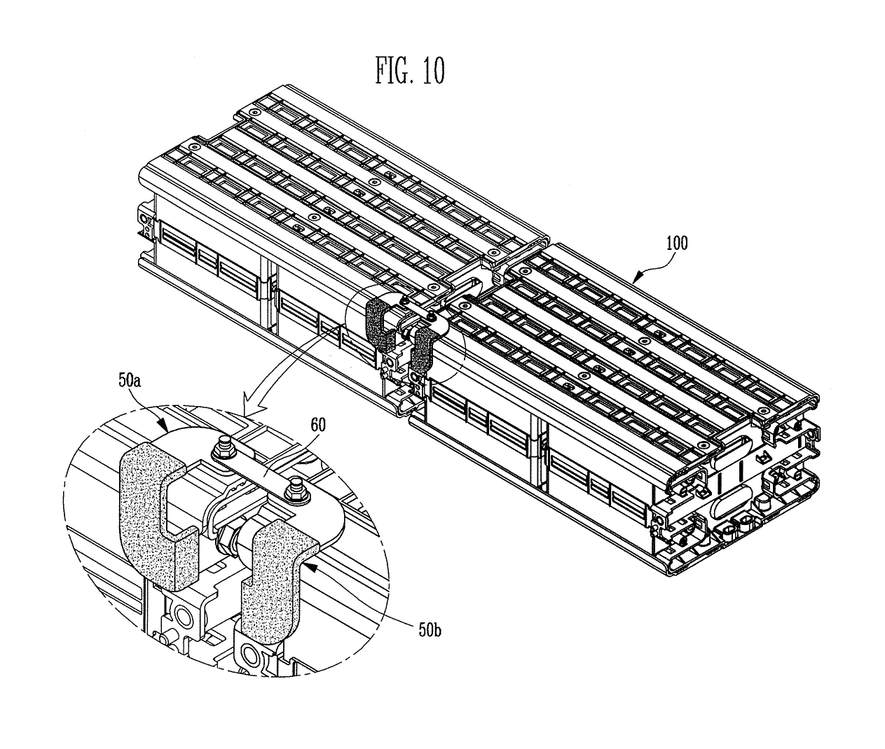

An array coupling type bus bar will be described with reference to FIGS. 8 to 10. FIG. 8 is an exploded perspective view illustrating an array coupling type bus bar according to an embodiment. FIG. 9 is a perspective view illustrating that the terminal of FIG. 8 is provided in a battery module. FIG. 10 is a perspective view illustrating that electrode terminals are coupled to each other using the bus bar of FIG. 8.

The array coupling type bus bar may be divided into a first terminal 56a, a first extending unit 57a, and a second extending unit 58a. When the plane including the first terminal 56a is a first plane, the first extending unit 57a is bent from the first terminal 56a to extend in second plane substantially perpendicular to the first plane (i.e., vertically, as shown in FIG. 8). The second extending unit 58a is bent from the upper end of the first extending unit 57a to extend in a third plane substantially perpendicular to the first plane and the second plane. In the first terminal 56a, as described above, an electrode accommodating hole 52 and a second probe hole 53 are formed. A fastening hole 54 is formed in the second extending unit 58a.

An array coupling type bus bar 50a is provided to make a pair with an array coupling type bus bar 50b symmetrical with the above described structure. In addition, the array coupling type bus bar 50a may include a module coupling unit 60 for coupling the fastening holes 54 of the second extending units 58a and 58b. The module coupling unit 60 may be provided in the form of a commonly used bus bar. In the module coupling unit 60, second fastening holes 61 are formed on both ends to be fastened to the above-described fastening holes 54 using a bolt and a nut. In order to secure facility in manufacturing and assembling processes, an integrated stud bolt may be used.

On the other hand, as described above, an insulating layer may be formed on a part of the first extending unit 57a and/or the second extending unit 58a that are easily exposed to the outside.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A horizontal coupling bus-bar for a battery module, the bus-bar comprising a conductive metal material, wherein the bus-bar has a curved center portion and has an electrode accommodating hole on either side of the curved center portion.

2. The horizontal coupling type bus-bar as claimed in claim 1, wherein a probe hole configured to receive a voltage testing apparatus is located adjacent to at least one electrode accommodating hole.

3. The horizontal coupling type bus-bar as claimed in claim 1, wherein an insulating layer is on the curved center portion.

4. A vertical coupling bus-bar for a battery module, the bus-bar comprising a conductive metal material and comprising:
a first terminal extending in a first plane and having a first electrode terminal accommodating hole;
a coupling unit extending in a second plane substantially perpendicular to the first plane and being coupled to the first terminal; and
a second terminal spaced from and extending substantially parallel to the first terminal and coupled to the coupling unit, wherein the second terminal has a second electrode terminal accommodating hole.

5. The horizontal coupling type bus-bar as claimed in claim 4, wherein a probe hole configured to receive a voltage testing apparatus is located adjacent at least one of the first electrode accommodating hole or the second electrode accommodating hole.

6. The horizontal coupling type bus-bar as claimed in claim 4, wherein an insulating layer is on the coupling unit.

7. An array coupling type bus-bar bus bar for a battery module, the bus-bar comprising a conductive metal material and comprising:
a first terminal extending in a first plane and having a first electrode terminal accommodating hole;
a first extending unit extending in a second plane substantially perpendicular to the first plane and coupled to the first terminal; and
a second extending unit extending in a third plane substantially perpendicular to the first plane and the second plane and coupled to the first extending unit.

8. The array coupling type bus-bar as claimed in claim 7, wherein an insulating layer in formed on the first extending unit and on the second extending unit.

9. The array coupling type bus-bar as claimed in claim 7, further comprising a module coupling unit comprising a conductive metal material and fastened to the second extending unit by a fastener.

10. The array coupling type bus-bar as claimed in claim 9, wherein the second extending unit and the module coupling unit are coupled to each other by an integrated stud bolt.

11. The array coupling type bus-bar as claimed in claim 9, wherein an insulating layer is on the module coupling unit.

12. The array coupling type bus-bar as claimed in claim 7, wherein a probe hole configured to receive a voltage testing apparatus is located adjacent to the electrode accommodating hole.

13. A battery module array comprising:
a plurality of battery modules each comprising a plurality of battery cells, each of the battery cells comprising a terminal surface through which electrode terminals are exposed and a bottom surface substantially opposite to the terminal surface, wherein the bottom surface of each of the battery cells are fixed together such that the exposed electrode terminals extend away from each other; and
a bus bar coupling the electrode terminals of two adjacent ones of the battery modules to each other, the bus bar comprising a conductive metal material, wherein the bus bar has a curved center portion and has an electrode accommodating hole on either side of the curved center portion.

14. The battery module array as claimed in claim 13,
wherein the battery array comprises a plurality of pairs of battery cells laminated together, wherein the pairs of battery cells are stacked to form layers,
wherein end plates are provided on ends of the battery array, and
wherein a fixing member is coupled to the end plates to fix the battery cells in the battery array.
